(19) United States
(12) Patent Application Publication
(10) Pub. No.: US 2014/0136263 A1
(43) Pub. Date: May 15, 2014

(54) USER EQUIPMENT AND METHOD FOR TRANSMITTING/RECEIVING EVENT USING CALENDAR PROTOCOL AT USER EQUIPMENT

(71) Applicant: SAMSUNG ELECTRONICS CO., LTD., Suwon-si (KR)

(72) Inventors: Suk-Jae LEE, Seoul (KR); Sang-Hyun PARK, Seoul (KR); Hui-Chul YANG, Yongin-si (KR); Sang-Ki LEE, Seoul (KR)

(73) Assignee: SAMSUNG ELECTRONICS CO., LTD., Suwon-si (KR)

(21) Appl. No.: 14/077,472

(22) Filed: Nov. 12, 2013

(30) Foreign Application Priority Data
Nov. 13, 2012 (KR) 10-2012-0128233

(51) Int. Cl. G06Q 10/10

(52) U.S. Cl. CPC G06Q 10/1095
USPC 705/7.19

(57) ABSTRACT

A user equipment that enables a user to transmit and receive an event using a calendar protocol in a calendar application is provided. The user equipment includes a calendar unit configured to store calendar data and display a calendar at a request of a user, an event managing unit configured to manage an event on the calendar, and an event transmitting/receiving unit configured to transmit an event of the user equipment to an external apparatus and receive an event from the external apparatus by using a certain calendar protocol.

### CROSS-REFERENCE TO RELATED APPLICATION(S)

This application claims the benefit under 35 U.S.C. §119(a) of a Korean patent application filed on Nov. 13, 2012 in the Korean Intellectual Property Office and assigned Serial No. 10-2012-0128233, the entire disclosure of which is hereby incorporated by reference.

### TECHNICAL FIELD

The present disclosure relates to a user equipment. More particularly, the present disclosure relates to a method for transmitting/receiving an event using a calendar protocol in a user equipment.

### BACKGROUND

Recently, a user equipment, such as a mobile device (for example, a cellular phone a smart phone, or a tablet Personal Computer (PC)), has various applications that can be executed by a selection of a user or automatically under a specific condition.

The term “application” is an abbreviation of an application program and refers to a purpose-dedicated application program. For example, the application may be a game program, a message transmission/reception program, a camera function program, a mobile Web browser, an e-mail program, and the like. The dictionary definition of the application is an “applied program”. When the term is used as a meaning in a mobile device, such as a smart phone, the term refers to all kinds of mobile applied programs, or may refer to all kinds of programs of a mobile device. For example, the application refers to all kinds of programs except system programs running on a controller Operating System (OS) of a mobile device, such as a smart phone, that is, each of the applied programs for example, a game program, an Internet browser, a compass, and a calculator.

An example of various applications as above may be a calendar application. If the user inputs an event at a specific date and time based on a calendar, the calendar application records an event at the corresponding date and time, and informs the user of the event at a date and time desired by the user. Further, the calendar application may be connected to the Web to perform synchronization with a third-party scheduling program on the Web so that an event on the calendar application is shared with the third-party scheduling program.

The user uses the calendar application as described above in order to managing their schedules. As the change of society becomes faster, newer and various functions are added to the calendar application so that the user may manage more schedules effectively. For example, the calendar application of the related art provides a function of inputting a date and time and an event name, but recently the current calendar application provides an additional function of inputting a location, participants, a memo, and a photograph of the event. Further, the calendar application of the related art is managed on one device, but recently the current calendar application may be managed on a plurality of different user equipments, such as a PC and a smart phone, at the same time by using a Web calendar and may store the event data stored on a separate Web server so that the event data stored on the Web server can be managed on a new user equipment even when the currently used user equipment has been lost.

Even though various additional functions have been provided as described above, the current calendar application does not provide a function in which the user can send and receive an event with a third-party user.

For example, if the user desires to send his or her own schedule to another person, the current calendar application uses another application, such as a message or an email, in a form of attachment to transmit the stored schedule. However, the transmission method like this does not transmit the stored schedule as it is, but converts the data into a message or an email format for transmission. Therefore, the original data may be damaged corresponding to the original schedule, and the method becomes complicated since the user should use another application other than the calendar application.

Further, the current calendar application uses the Web calendar to share the same calendar and share events by giving desired users authorization for viewing and editing events on the calendar. However, in this case, the users should have accounts on the same Web page, and should set additional authorization to share events. Otherwise, the method of sharing the event is limited since only users having corresponding authorization can view shared events, and it is difficult to share an event for one time.

Therefore, a need exists for a method for transmitting/receiving an event using a calendar protocol in a user equipment.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a user equipment that enables a user to transmit and receive an event using a calendar protocol in a calendar application so that the event is transmitted or received as it is, and a method for transmitting and receiving an event using a calendar protocol in a calendar application by the user equipment.

Another aspect of the present disclosure is to provide a user equipment that enables the user to select event recipients for each event by transmitting the event to at least one third-party user with whom the user desires to share a specific event in each calendar application, not by sharing the event with accounts on the same Web site, and a method for transmitting and receiving an event using the calendar protocol by the user equipment.

Another aspect of the present disclosure is to provide a user equipment that enables a user to select various event reception/transmission objects by setting the event reception/transmission objects in a calendar application to be various subjects including acquaintances whom the user knows, third-party users whom the user does not know, service providers, and third-party application servers, and a method for transmitting and receiving an event using the calendar protocol by the user equipment.

Another aspect of the present disclosure is to provide a user equipment that enables any subject to transmit and receive an event in a calendar application using a calendar protocol by providing the common calendar protocol for event transmission and reception between calendar applications, and a method for transmitting and receiving an event using the calendar protocol by the user equipment.

At least one of the aspects of the present disclosure described above may be achieved by the following components.

In accordance with an aspect of the present disclosure, a user equipment is provided. The user equipment includes a calendar unit configured to store calendar data and display a calendar at a request of a user, an event managing unit configured to manage an event on the calendar, and an event transmitting/receiving unit configured to transmit an event from the user equipment to an external apparatus and receive an event from the external apparatus by using a calendar protocol.

In accordance with another aspect of the present disclosure, a method of transmitting an event using a calendar protocol from a user equipment is provided. The method includes displaying an event on a calendar, selecting an event and an external apparatus to which the event is to be transmitted, and transmitting the selected event to the external apparatus using the calendar protocol.

In accordance with another aspect of the present disclosure, a method of receiving an event using a calendar protocol by a user equipment is provided. The method includes receiving an event using the calendar protocol from an external apparatus, and displaying the received event on a corresponding date and time on a calendar.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1 and 2 are schematic diagrams illustrating event transmission and reception using a calendar protocol in a user equipment according to an embodiment of the present disclosure;

FIG. 3 is a diagram illustrating a configuration of a user equipment according to an embodiment of the present disclosure;

FIG. 4 is a flowchart illustrating a process of generating and storing a user event by a user equipment according to an embodiment of the present disclosure;

FIG. 5 is a diagram illustrating a screen of a calendar application according to an embodiment of the present disclosure;

FIGS. 6A and 6B are diagrams illustrating a screen for creating a list-type event according to an embodiment of the present disclosure;

FIG. 7 is a diagram illustrating a screen for creating a template-type event according to an embodiment of the present disclosure;

FIG. 8 is a flowchart illustrating a process for transmitting a calendar application event from a user equipment according to an embodiment of the present disclosure;

FIG. 9 is a flowchart illustrating a method for receiving a calendar application event by a user equipment according to an embodiment of the present disclosure;

FIGS. 10A and 10B are diagrams illustrating events received by a user equipment according to an embodiment of the present disclosure;

FIG. 11 is a diagram illustrating an event transmitted or received by a user equipment according to an embodiment of the present disclosure; and

FIG. 12 is a diagram illustrating a screen for an event transmission/reception setting in a user equipment according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

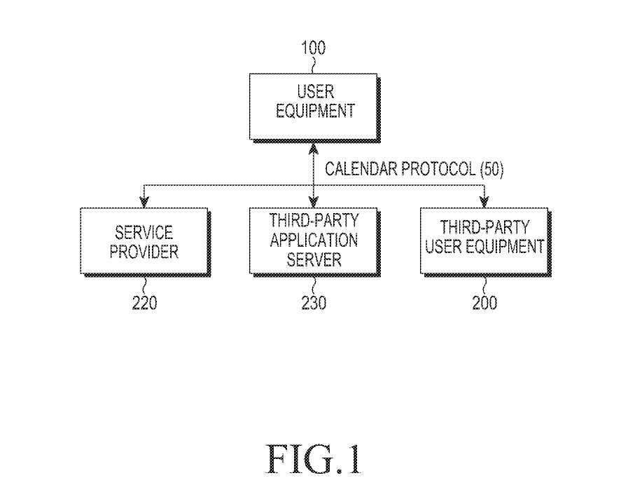

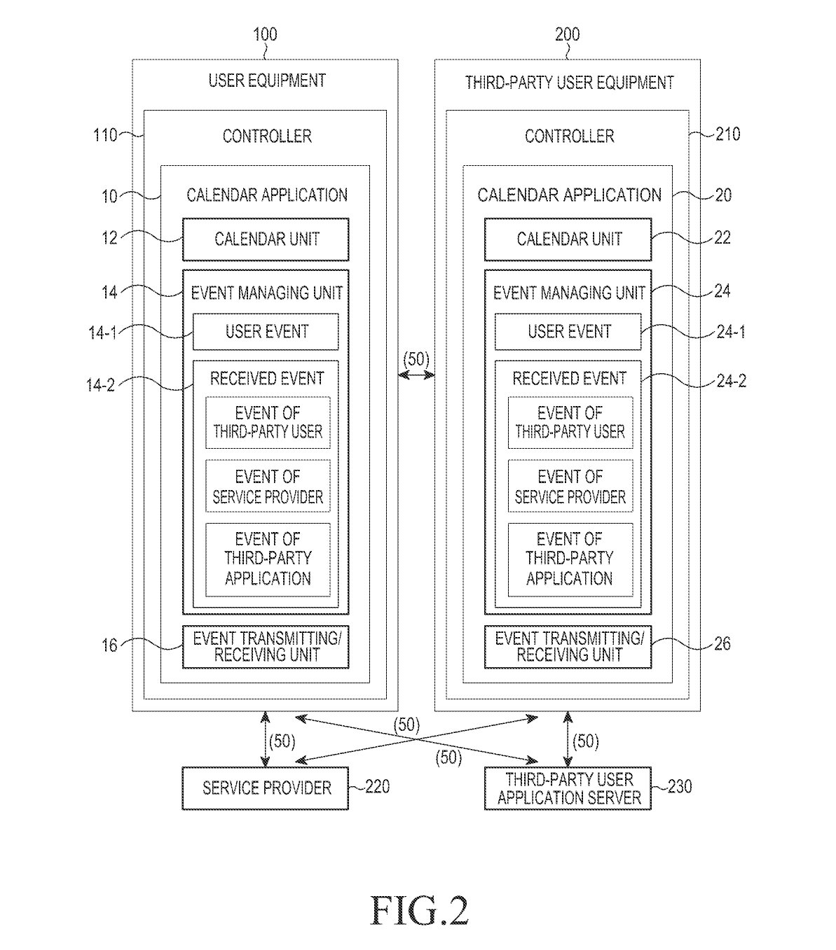

FIGS. 1 and 2 are schematic diagrams illustrating event transmission and reception using a calendar protocol in a user equipment according to an embodiment of the present disclosure.

Referring to FIG. 1, a user equipment 100 has a calendar application 10, and uses the calendar protocol 50 to transmit or receive an event with a service provider 220, a third-party application server 230, and a third-party user equipment 200.

The calendar application 10 is an application program executed in the user equipment 100. If a user inputs an event for a specific date and a specific time based on a calendar according to the calendar application 10, the user equipment 100 stores an event on the corresponding date and time and displays content of the event when the user selects the stored event. Further, the user equipment 100 performs an alarm function of informing of the stored event on the date and time desired by the user according to the calendar application 10, or shares the event in the calendar application with a third-party scheduler program by connecting to the Web and synchronizing the event with the third-party scheduler program on the Web.

A user equipment of the related art does not provide a function of directly transmitting an event to an external apparatus or directly receiving an event from an external apparatus with a calendar application, but the user equipment 100 uses the calendar protocol 50 to transmit or receive a calendar application event with an external apparatus, such as the third-party user equipment 200, the third-party application server 230, and the service provider 220.

The third-party user equipment 200 is a third-party user's equipment on which the calendar application is installed. The third-party application server 230 provides third-party applications, such as a game application, a message transmission/reception application, and a camera application and provides information relating to third-party applications. The service provider 220 is a service provider that provides various services using a communication network.

The user equipment 100 may be a mobile device, such as a cellular phone, a smart phone, or a tablet Personal Computer (PC), or an electronic apparatus, such as a personal computer. Any electronic apparatus is possible as long as the electronic apparatus can execute the calendar application 10. The user equipment 100 may perform a communication through a wired or wireless communication network with the third-party user equipment 200, the third-party application server 230, and the service provider 220. Especially, according to an embodiment of the present disclosure, the user equipment 100 transmits or receives an event using the calendar protocol 50.

Referring to FIG. 2, the user equipment 100 transmits and receives an event using the calendar protocol 50 with the third-party user equipment 200, the third-party application server 230, and the service provider 220. With reference to FIG. 2, the user equipment 100 includes a controller 110 that performs general control operations for the user equipment 100, and performs a calendar application function according to the calendar application 10 with the controller 110. The third-party user equipment 200 may be an equipment that includes a controller 210 that performs general control operations for the third-party user equipment 200 similar to the user equipment 100 and performs a calendar application function according to a calendar application 20 with the controller 210.

According to an embodiment of the present disclosure, the calendar application 10 includes a calendar unit 12, an event managing unit 14, and an event transmitting/receiving unit 16.

The calendar unit 12 performs a calendar function. The calendar function is a function of storing calendar data and displaying a calendar at the request of the user.

The event managing unit 14 manages an event corresponding to a specific date and/or time on a calendar. At this point, the event managing unit 14 manages a user event 14-1, and a received event 14-2. The user event 14-1 is a user event input by the user, and may be a schedule of the user. The schedule of the user may include a time, a location, a position, participants, a schedule, an image, and the like. The received event 14-2 is an event received from an external apparatus, and may include an event of a third-party user, an event of a service provider, and an event of a third-party application. The event of the third-party user may be a schedule of the third-party user, which is received from the third-party user equipment 200. The event of the service provider may be a schedule of a specific service provided by a service provider, which is received from the service provider 220. The event of the third-party application may be a schedule relating to the third-party application received from the third-party application server 230.

Similar to the calendar application 10, the calendar application 20 includes a calendar unit 22, an event managing unit 24, and an event transmitting/receiving unit 26. The event managing unit 24 manages an event corresponding to a specific date and/or time on a calendar. At this point, the event managing unit 24 manages a user event 24-1, and a received event 24-2.

The event transmitting/receiving unit 16 uses the calendar protocol 50 to transmit an event from the user equipment 100 to an external apparatus, such as the third-party user equipment 200, the third-party application server 230, or the service provider 220, and to receive an event from at least one of external apparatuses, such as the third-party user equipment 200, the third-party application server 230, and the service provider 220. At this point, the calendar protocol 50 may be an open calendar protocol that can be commonly used by the user equipment 100, the third-party user equipment 200, the third-party application server 230, and the service provider 220.

The user equipment 100 described above is a mobile device, such as a smart phone. If it is assumed that the user equipment 100 is applied to a mobile device, the configuration of the mobile device is described as follows.

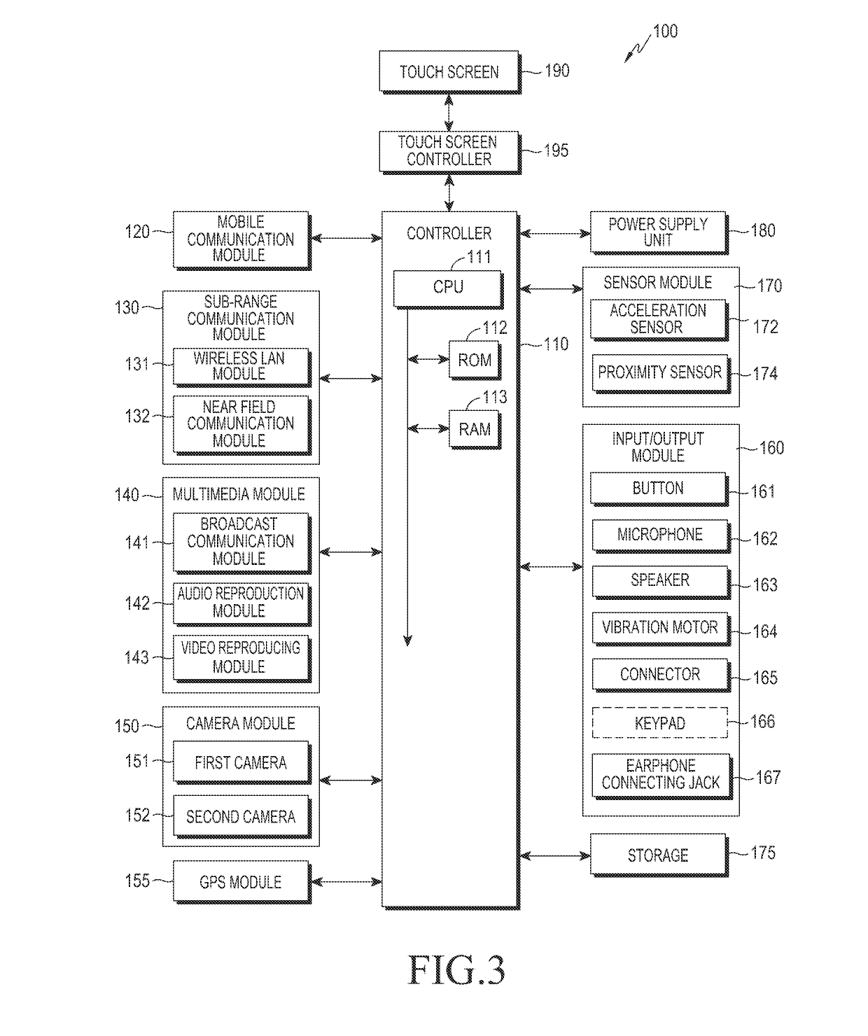

FIG. 3 is a diagram illustrating a configuration of a user equipment according to an embodiment of the present disclosure.

Referring to FIG. 3, the user equipment 100 may be connected to an external device (not illustrated) using a mobile communication module 120, a sub-communication module 130, and a connector 165. The external device includes another apparatus (not illustrated), a cellular phone (not illustrated), a smart phone (not illustrated), a tablet PC (not illustrated), and a server (not illustrated).

Referring to FIG. 3, an apparatus (the user equipment) 100 includes a touch screen 190 and a touch screen controller 195. Further, the apparatus 100 includes the controller 110, the mobile communication module 120, the sub-communication module 130, a multimedia module 140, a camera module 150, a Global Positioning System (GPS) module 155, an input/output module 160, a sensor module 170, a power supply unit 180, and a storage unit 175. The sub-communication module 130 includes at least one of a wireless Local Area Network (LAN) module 131 and a near field communication module 132. The multimedia module 140 includes at least one of a broadcast communication module 141, an audio reproducing module 142, and the video reproducing module 143. The camera module 150 includes at least one of the first camera 151 and a second camera 152, and the input/output module 160 includes at least one of buttons 161, a microphone 162, a speaker 163, a vibration motor 164, the connector 165, a keypad 166, and an earphone jack 167.

The controller 110 may include a Central Processing Unit (CPU) 111, a Read-Only Memory (ROM) 112 in which a control program for controlling the apparatus 100 is stored, and a Random-Access Memory (RAM) 113 that stores signals or data input from the outside of the apparatus 100 or that is used as a storage area for an operation performed in the apparatus 100. The CPU 111 may include a single core processor, a dual-core processor, a triple-core processor, a quad-core processor. The CPU 111, the ROM 112, and the RAM 113 may be connected to each other through an internal bus.

The controller 110 may control the mobile communication module 120, the sub-communication module 130, the multimedia module 140, the camera module 150, the GPS module 155, the input/output module 160, the sensor module 170, the power supply unit 180, the storage unit 175, the touch screen 190, and the touch screen controller 195.

The controller 110 has the calendar application 10, performs a calendar application function according to the calendar application 10, and performs a control operation used for the calendar application.

The mobile communication module 120 uses one or a plurality of antennas (not illustrated) under the control of the controller 110 so that the apparatus 100 is connected to an external apparatus through a mobile communication. The mobile communication module 120 transmits or receives wireless signals for a voice communication, a video communication, a Short Message Service (SMS), and a Multimedia Message Service (MMS) with a cellular phone (not illustrated), a smart phone (not illustrated), a tablet PC, or another apparatus (not illustrated), which has a phone number input to the apparatus 100.

The sub-communication module 130 may include at least one of the wireless LAN module 131 and the near field communication module 132. For example, sub-communication module 130 includes the wireless LAN module 131, includes the near field communication module 132, or includes both of the wireless LAN module 131 and the near field communication module 132.

The wireless LAN module 131 may be connected to the Internet at a position where a wireless Access Point (AP) is installed under the control of the controller 110. The wireless LAN module 131 conforms to a wireless LAN standard (IEEE 802.11x) of Institute of Institute of Electrical and Electronics Engineers (IEEE). The near field communication module 132 may perform a near field communication with the apparatus 100 and the image forming apparatus (not illustrated) under the control of the controller 110. The near field communication may include Bluetooth, infrared data association (IrDA), or the like.

The apparatus 100 may include at least one of the mobile communication module 120, the wireless LAN module 131, and the near field communication module 132 depending on the performance. For example, the apparatus 100 may include a combination of the mobile communication module 120, the wireless LAN module 131, and the near field communication module 132, depending on the performance.

The multimedia module 140 may include the broadcast communication module 141, the audio reproducing module 142, or the video reproducing module 143. The broadcast communication module 141 may receive broadcast signals (for example, TV broadcast signals, radio broadcast signals, or data broadcast signals) and the additional broadcast information (for example, Electric Program Guide (EPS) or Electric Service Guide (ESG)) under the control of the controller 110. The audio reproducing module 142 may reproduce digital audio files (for example, with file extensions of mp3, wma, ogg, or way) which are stored or received under the control of the controller 110. The video reproducing module 143 may reproduce digital video files (for example, with file extensions of mpeg, mpg, mp4, avi, mov, or mkv) which are stored or received under the control of the controller 110. The video reproducing module 143 may reproduce digital audio files.

The multimedia module 140 may include the audio reproducing module 142 and the video reproducing module 143 excluding the broadcast communication module 141. Further, the audio reproducing module 142 or the video reproducing module 143 of the multimedia module 140 may be included in the controller 110.

The camera module 150 may include at least one of the first camera 151 and the second camera 152 that capture still images or moving images under the control of the controller 110. Further, the first camera 151 or the second camera 152 may include an auxiliary light source that provides a light amount used for capturing (for example, a flash (not illustrated)). The first camera 151 may be disposed on the front surface of the apparatus 100, and the second camera 152 may be disposed on the rear surface of the apparatus 100.

The GPS module 155 receives electric waves from a plurality of GPS satellites (not illustrated) in the Earth's orbit, and may calculate the position of the apparatus 100 using the Time of Arrival (TOA) from the GPS satellites (not illustrated) to the apparatus 100.

The input/output module 160 may include at least one of the plurality of the buttons 161, the microphone 162, the speaker 163, the vibration motor 164, the connector 165, the keypad 166, and an earphone jack 167.

The buttons 161 may be formed on the front surface, a side surface, or the rear surface of the apparatus 100, and may include at least one of a power/lock button (not illustrated), a volume button (not illustrated), a menu button, a home button, a back button, and a search button.

The microphone 162 generates an electric signal by receiving a voice or a sound under the control of the controller 110.

The speaker 163 may output a sound corresponding to various signals (for example, wireless signals, broadcast signals, digital audio files, digital video files, or image capturing) of the mobile communication module 120, the sub-communication module 130, the multimedia module 140, or the camera module 150 under the control of the controller 110. The speaker 163 may output a sound (for example, a button operation sound corresponding to a telephone communication or a communication connection sound) corresponding to a function performed by the apparatus 100. One or more speakers 163 may be formed at a position(s) appropriate for the apparatus 100.

The vibration motor 164 may convert electric signals into mechanical vibrations under the control of the controller 110. For example, when the apparatus 100 in the vibration mode receives a voice communication from another apparatus (not illustrated), the vibration motor 164 operates. One or more apparatuses 100 may be formed in the housing of the apparatus 100. The vibration motor 164 may operate in response to touch operations of the user who touches the touch screen 190 or in response to continuous movements of the touch on the touch screen 190.

The connector 165 may be used as an interface for connecting the apparatus 100 to an external device (not illustrated) or a power source (not illustrated). The connector 165 may transmit data stored in the storage unit 175 of the apparatus 100 to an external apparatus (not illustrated) or may receive data from an external apparatus (not illustrated) through a wire cable connected to the connector 165 under the control of the controller 110. The connector 165 may receive electric power from a power source (not illustrated) through a wire cable connected to the connector 165 or may recharge a battery (not illustrated).

The keypad 166 may receive key input in the user for the control of the apparatus 100. The keypad 166 includes a physical keypad (not illustrated) formed on the apparatus 100 or a virtual keypad (not illustrated) displayed on the touch screen 190. The physical keypad (not illustrated) formed on the apparatus 100 may be excluded depending on the performance or the structure of the apparatus 100.

The sensor module 170 includes at least one sensor that detects the status of the apparatus 100. For example, the sensor module 170 may include a proximity sensor 174 that detects whether the user is close to the apparatus 100, an illuminance sensor (not illustrated) that detects the amount of light near the apparatus 100, and an acceleration sensor 172 that detects operations of the apparatus 100 (for example, the rotation of the apparatus 100, or the acceleration or the vibration applied to the apparatus 100). The at least one sensor may detect the state of the apparatus 100, including the direction and the inclination, generate a signal corresponding to the detection, and transmit the generated signal to the controller 110. The sensor of the sensor module 170 may be added or removed depending on the performance of the apparatus 100.

The power supply unit 180 may provide electric power to one or a plurality of batteries included in the housing of the apparatus 100 under the control of the controller 110. The one or the plurality of batteries (not illustrated) provide power to the apparatus 100. Further, the power supply unit 180 may supply power input from an external power source (not illustrated) to the apparatus 100 through a wire cable connected to the connector 165.

The storage unit 175 may store signals or data that are input/output corresponding to the operations of the mobile communication module 120, the sub-communication module 130, the multimedia module 140, the camera module 150, the GPS module 155, the input/output module 160, the sensor module 170, and the touch screen 190 under the control of the controller 110. The storage unit 175 may store control programs or applications for controlling the apparatus 100 or the controller 110.

The terminology “storage unit” includes the storage unit 175, the ROM 112 and the RAM 113 in the controller 110, or a memory card (not illustrated), such as a Secure Digital (SD) card or Memory Stick, installed in the apparatus 100. The storage unit may include a non-volatile memory, a volatile memory, a Hard Disk Drive (HDD), or a Solid State Drive (SSD).

The touch screen 190 may provide the user with user interfaces corresponding to various services (for example, a communication, a data transmission, broadcasting, an image capturing, and the like). The touch screen 190 may transmit analog signals corresponding to the at least one touch input to the user interface to the touch screen controller 195. The touch screen 190 may receive at least one touch through the body of the user (for example, a finger including a thumb) or a touchable input unit (for example, a stylus pen). Further, the touch screen 190 may receive a continuous movement of one touch among the at least one touch. The touch screen 190 may transmit analog signals corresponding to the continuous movement of the received touch to the touch screen controller 195.

According to the present disclosure, the touch is not limited to the touch of the touch screen 190 with the body of the user or the touchable input unit, but may include a non-contact (for example, a detectable distance between the touch screen 190 and the body of the user or the touchable input unit is less than 1 mm) The distance that is detectable by the touch screen 190 may be changed depending on the performance or the structure of the apparatus 100.

For example, the touch screen 190 may be, for example, realized by a resistive touch screen, a capacitive touch screen, an infrared touch screen, or an acoustic wave touch screen.

The touch screen controller 195 converts the analog signals received from the touch screen 190 into digital signals to transmit the converted signals to the controller 110. The controller 110 controls the touch screen 190 by using the digital signals received from the touch screen controller 195. For example, the controller 110 respond to the touch so that a shortcut icon (not illustrated) displayed on the touch screen 190 may be selected or a shortcut icon (not illustrated) may be executed. Further, the touch screen controller 195 may be included in the controller 110.

According to an embodiment of the present disclosure, the mobile device 100 configured as described above, that is, the user equipment 100, drives a calendar application at the request of the user, and receives an event from the user through the calendar application to generate and store the user event. Further, the user equipment 100 transmits the previously generated or stored user event to at least one external apparatus at the request of the user or receives and stores the external event from the external apparatus. The at least one external apparatus may be the third-party user equipment 200, the third-party application server 230, and the service provider 220.

Hereinafter, a description is made to a method of receiving and storing a user event by the user equipment 100 according to an embodiment of the present disclosure.

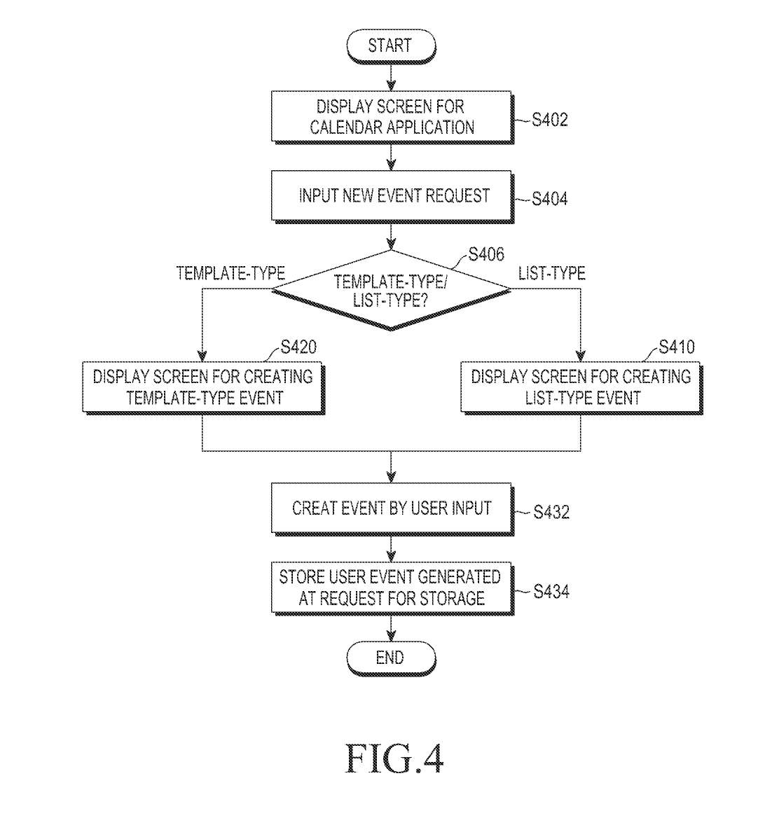

FIG. 4 is a flowchart illustrating a process of generating and storing a user event by a user equipment according to an embodiment of the present disclosure.

Referring to FIG. 4, the user equipment 100 drives the calendar application 10 and displays a calendar application screen on the touch screen 190 at the request of the user, that is, according to an input of a touch gesture corresponding to the request to execute the calendar application 10 by the user at operation S402.

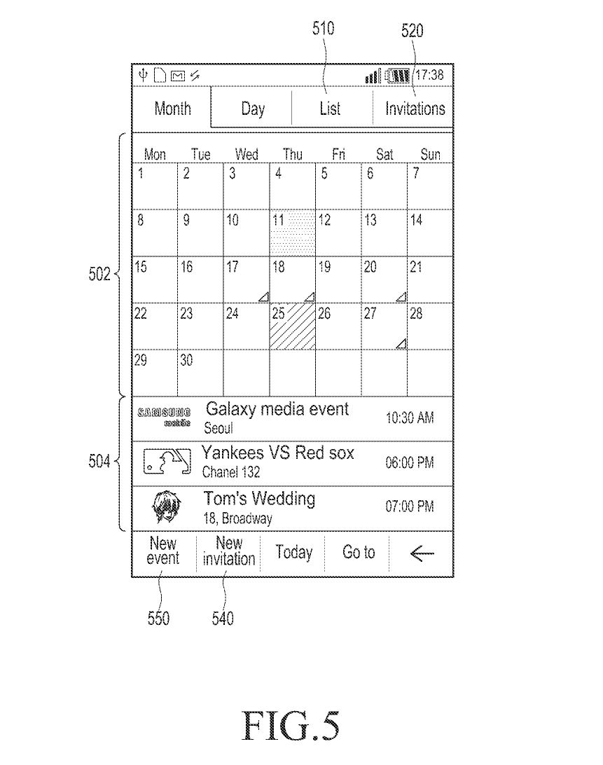

For example, in a case of a screen of a calendar application, FIG. 5 is a diagram illustrating a screen of a calendar application according to an embodiment of the present disclosure.

Referring to FIG. 5, a calendar 502 and at least one event 504 may be displayed on the screen of the calendar application. The events may be any one type of events among a list type or a template type. For example, according to an embodiment of the present disclosure, the template may be “Invitation” that includes content relating to an invitation, but other types of templates other than an invitation may be possible. On the upper portion of the screen of the calendar application, List 510 for indicating a list-type event or Invitations 520 for indicating a template-type event may be displayed. Further, on the lower portion of the screen of the calendar application, New Event 550 for receiving a request for generating a new list-type event and New Invitation 540 for receiving a request for generating a new template-type event may be displayed.

At operation S404, a user performs a request for generating a new event with a touch gesture. At operation S406, the user equipment 100 determines whether the request is a request for generating a new list-type event or a request for generating a new template-type event. For example, the user equipment 100 may determine that the request is a request for generating a new list-type event if the user touches New Event 550 and may determine that the request is a request for generating a new template-type event if the user touches New Invitation 540.

If it is determined at operation S406 that the request is a request for generating a new list-type event, the user equipment 100 displays a screen for creating a list-type event at operation S410.

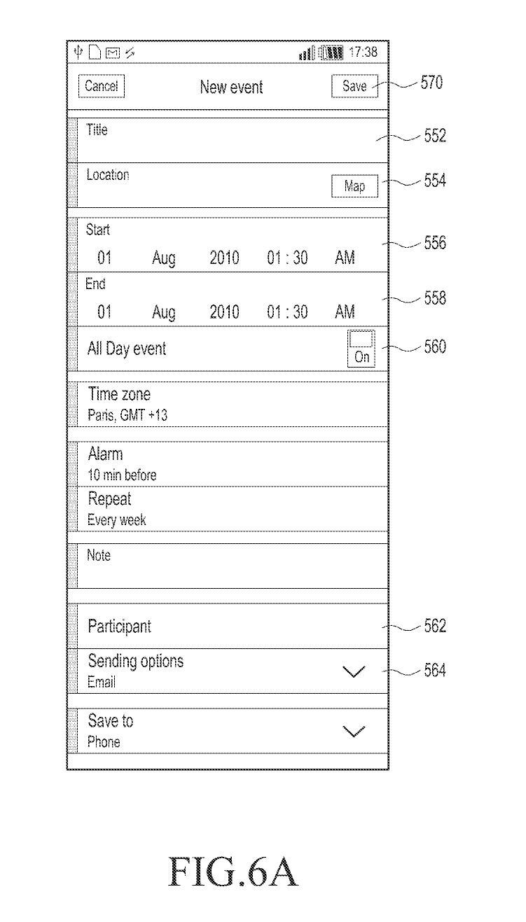

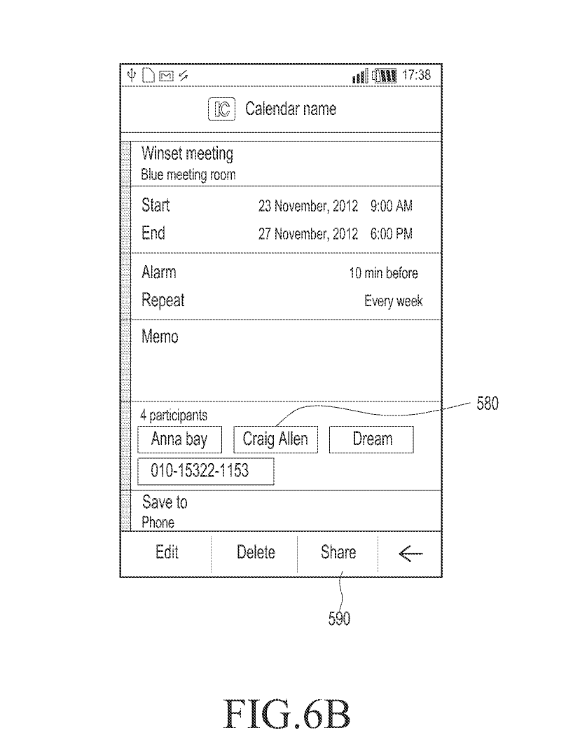

For example, in a case of a screen for creating a list-type event, FIGS. 6A and 6B are diagrams illustrating a screen for creating a list-type event according to an embodiment of the present disclosure.

Referring to FIG. 6A, input boxes for inputting at least one item of event content may be displayed on the screen for creating a list-type event. At this point, the event content may include a Title 552, a Location 554, a Start 556, an End 558, an All Day Event 560, a Participant 562, and Sending Options 564. The user may create a list-type event by inputting the Title 552, the Location 554, the Start 556, the End 558, the All Day Event 560, the Participant 562, and the Sending Options 564 on the screen for creating a list-type event. At this point, the Participant 562 is a participant who participates in the event, and a plurality of participants may be selected or input. The Sending Options 564 is to set an option for an event transmission, and the user can set in what transmission format the event is to be transmitted. According to an embodiment of the present disclosure, a setting may be performed so that the event transmission is performed by using the calendar protocol 50.

In the screen for creating the list-type event, after creating a list-type event, if the user touches Save 570 for a storage request, the stored user event may be displayed as illustrated in FIG. 6B.

Referring to FIG. 6B, the title of the event is stored as “Winset meeting”, the position of the event is stored as “Blue meeting room”, the starting time and the ending time are stored as “23 November, 2012 9:00 AM” and “23 November, 2012 6:00 PM”, the alarm and the repetition are stored as “10 min before” and “Every week”, the scheduling event is stored as “Memo”, and the participants are stored as “Anna bay, Craig Allen, Dream, 010-15322-1153”. At this point, the user may perform an event transmission request by selecting any one of the participants, for example, Craig Allen 580, with a touch to perform an event transmission request. In addition, the user may share the event with the participants by selecting “Share 590”.

Referring back to FIG. 4, if it is determined at operation S406 that the user performs a request for generating a template-type event, the user equipment 100 displays a screen for creating a template-type event at operation S420.

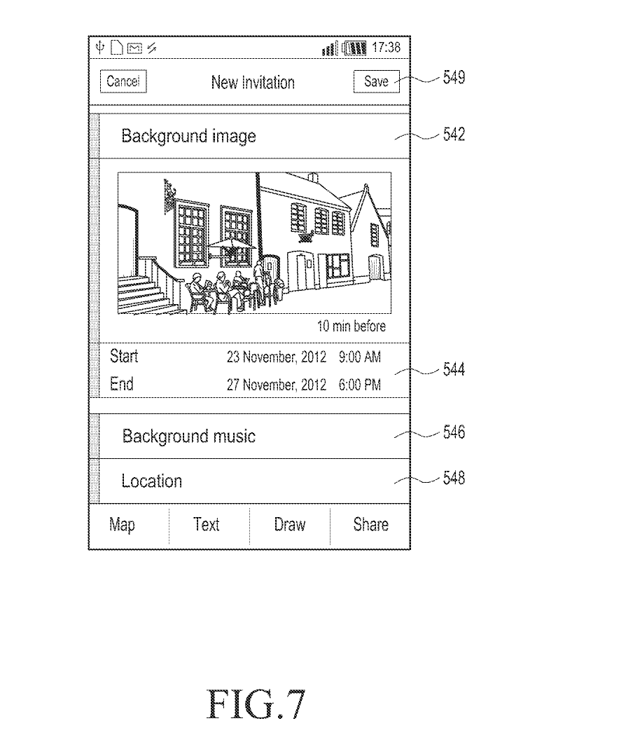

For example, in a case of a screen for creating a template-type event, FIG. 7 is a diagram illustrating a screen for creating a template-type event according to an embodiment of the present disclosure.

Referring to FIG. 7, the screen for creating the template-type event may be configured by selecting (inputting) at least one wallpaper image 542 with a touch, inputting the Start and End 544 with touches, inputting (selecting) Background Music 546 with a touch, and inputting (selecting) Location 548 with a touch. In the screen for creating the template-type event, after creating a template-type event, the user may submit a storage request by touching Save 549.

The user equipment 100 may generate a user event by user inputs, such as touches on the screen, for creating the list-type event or the screen for creating the template-type event at operation S432. The user equipment 100 stores the generated user event according to the storage request by the user at operation S434.

According to an embodiment of the present disclosure, the user event stored as described above may be transmitted to an external apparatus, for example, the third-party application server 230 and the service provider 220 as well as the third-party user equipment 200, at the request of the user. Hereinafter, a description is made of a case where the user event is transmitted to the third-party user equipment 200. However, it should be understood that the user event may be transmitted to the third-party application server 230 and the service provider 220 as well as the third-party user equipment 200.

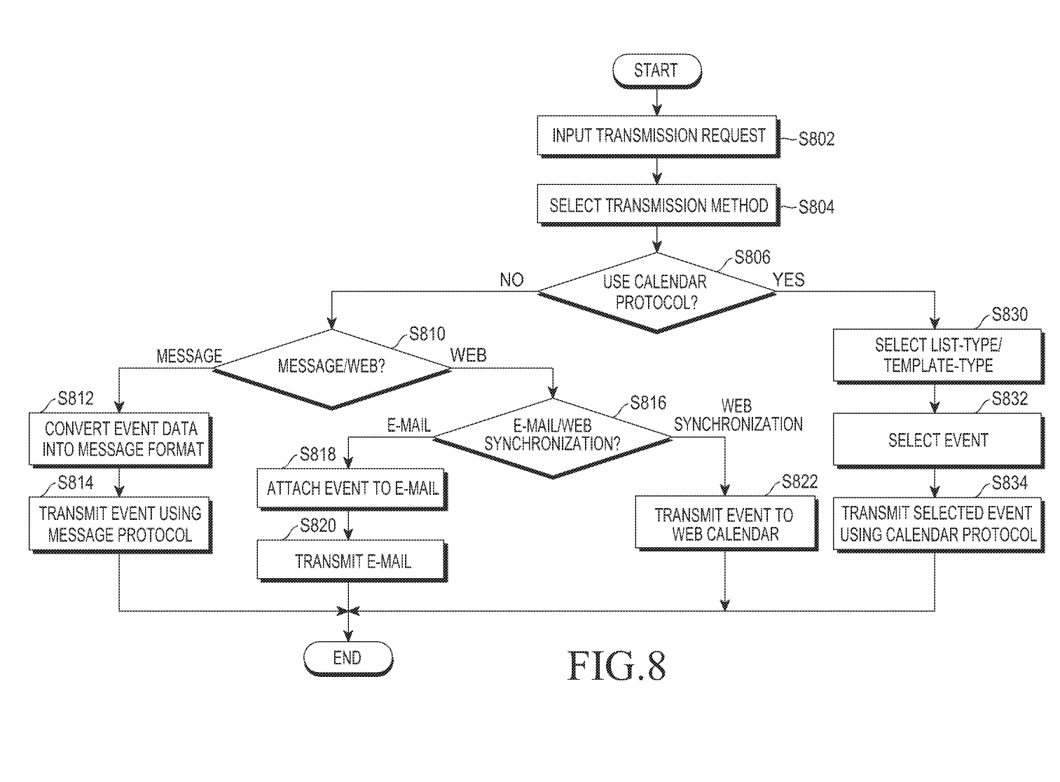

FIG. 8 is a flowchart illustrating a process for transmitting a calendar application event from a user equipment according to an embodiment of the present disclosure.

Referring to FIG. 8, if the user inputs a request for transmitting an event with a touch on the calendar application at operation S802 and a transmission method is selected at operation S804, the user equipment 100 determines whether the transmission method is a transmission method using a calendar protocol at operation S806.

If the transmission method is not a transmission method using a calendar protocol, the user equipment 100 determines whether to transmit the event by a message transmission method or by the Web at operation S810. If the event is transmitted by the message transmission method, the user equipment 100 converts the event data to be transmitted into a message format at operation S812. At this point, the message format can be an SMS message format, an MMS message format, or the like. The user equipment 100 converts the event data into a message format, and transmits the converted event data by using a message transmission protocol, for example, an SMS message transmission protocol or an MMS message transmission protocol at operation S814. If the event is transmitted by the Web, the user equipment 100 determines whether the event is to be transmitted by an e-mail or by the Web synchronization at operation S816. If the event is transmitted by an e-mail, the user equipment 100 attaches the event content to the e-mail at operation S818, and transmits the corresponding e-mail by the Web at operation S820. If the event is transmitted by the Web synchronization, the user equipment 100 transmits the event content to the Web calendar so that synchronization is performed through the Web calendar at operation S822.

If the transmission method is a transmission method using a calendar protocol, the user selects whether to transmit a list-type event or a template-type event by a touch for the user equipment 100 at operation S830, and receives a selection of an event to be transmitted at operation S832. Further, the user equipment 100 transmits the selected event with the calendar protocol at operation S834.

Meanwhile, according to an embodiment of the present disclosure, the user equipment 100 receives a calendar application event from an external apparatus, for example, the third-party application server 230 or the service provider 220 as well as the third-party user equipment 200.

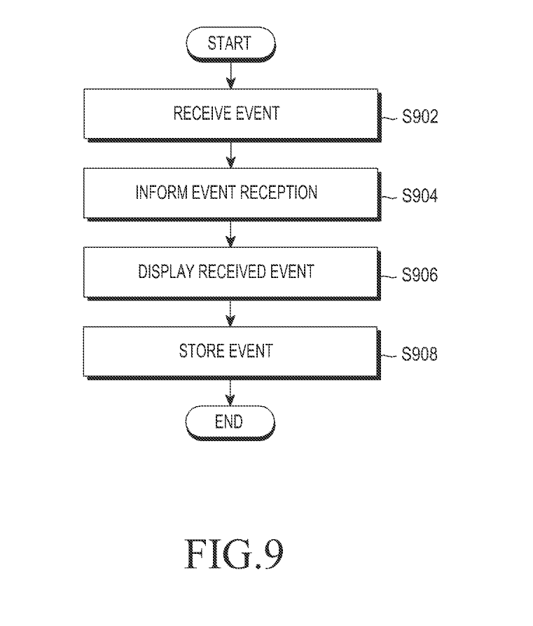

FIG. 9 is a flowchart illustrating a method for receiving a calendar application event from a user equipment according to an embodiment of the present disclosure.

Referring to FIG. 9, the user equipment 100 may receive a calendar application event from at least one external apparatus, for example, the third-party application server 230 and the service provider 220 as well as the third-party user equipment 200. If the event is received at operation S902, the user equipment 100 informs that the event has been received at operation S904. At this point, the user equipment 100 may display a message informing that the event has been received or output a vibration or a sound.

Further, the user equipment 100 displays the received event at the request of the user at operation S906. At this point, the received event may be any one of the list-type event and the template-type event.

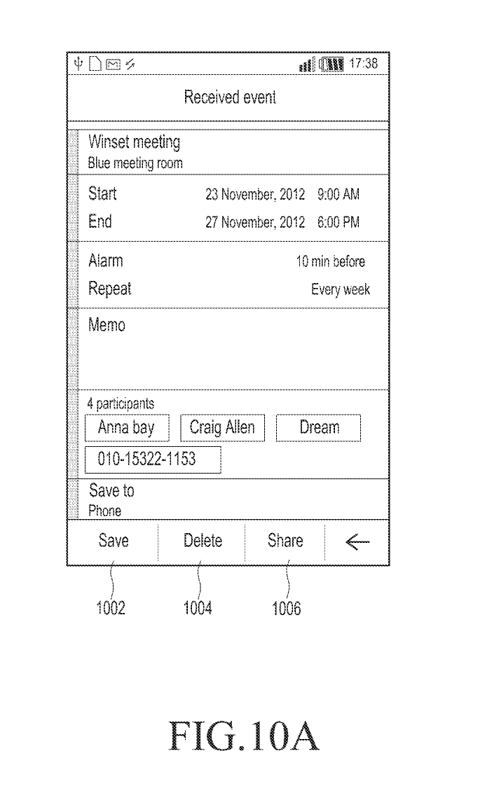

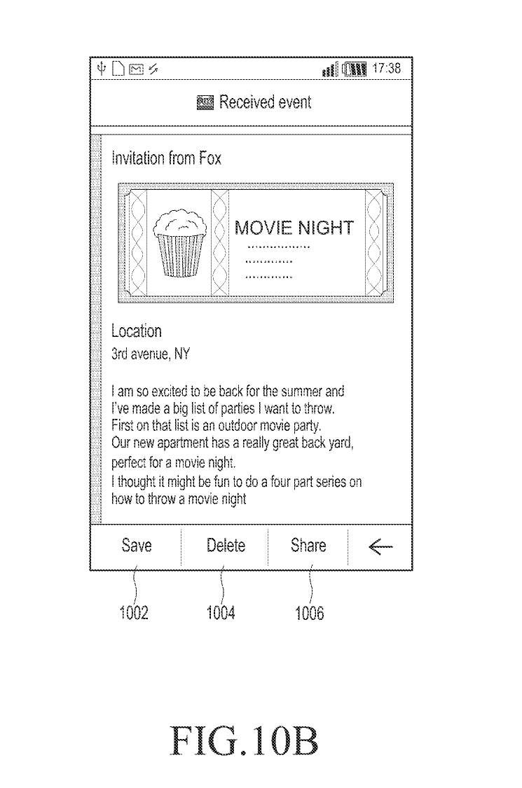

FIGS. 10A and 10B are diagrams illustrating events received in a user equipment according to an embodiment of the present disclosure.

Referring to FIGS. 10A and 10B, the user equipment 100 may receive and display the list-type event as illustrated in FIG. 10A or the template-type event as illustrated in FIG. 10B. At this point, screens for displaying the received events as illustrated in FIGS. 10A and 10B may include Save 1002 for storing the received event, Delete 1004 for deleting the received event, and Share 1006 for sharing the received event.

The user equipment 100 stores the received event as the user selects the Save 1002 with a touch on the screen for displaying the received event at operation S908. At this point, the stored event may be displayed together with the user event on the calendar.

Meanwhile, the user equipment 100 may display event transmission/reception history at the request of the user after transmitting or receiving an event as described above.

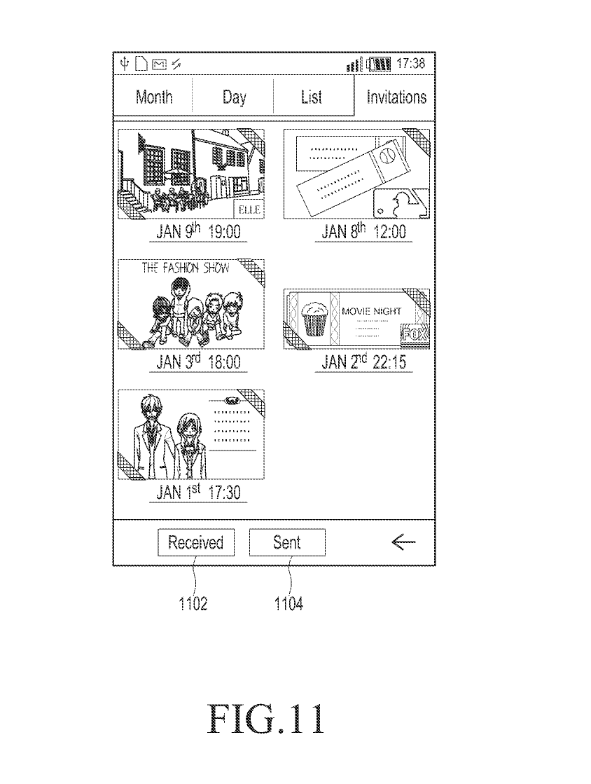

FIG. 11 is a diagram illustrating an event transmitted or received by a user equipment according to an embodiment of the present disclosure. FIG. 11 illustrates a transmitted or received template-type event, for example, a transmitted or received event of Invitation.

Referring to FIG. 11, if the user selects Received 1102, the user equipment 100 displays the received template-type event. Further, if Sent 1104 is selected with a touch by the user, the user equipment 100 displays the transmitted template-type event.

Further, the user equipment 100 may add or remove an event transmission/reception object and may set whether to receive an event from a specific event transmission/reception object.

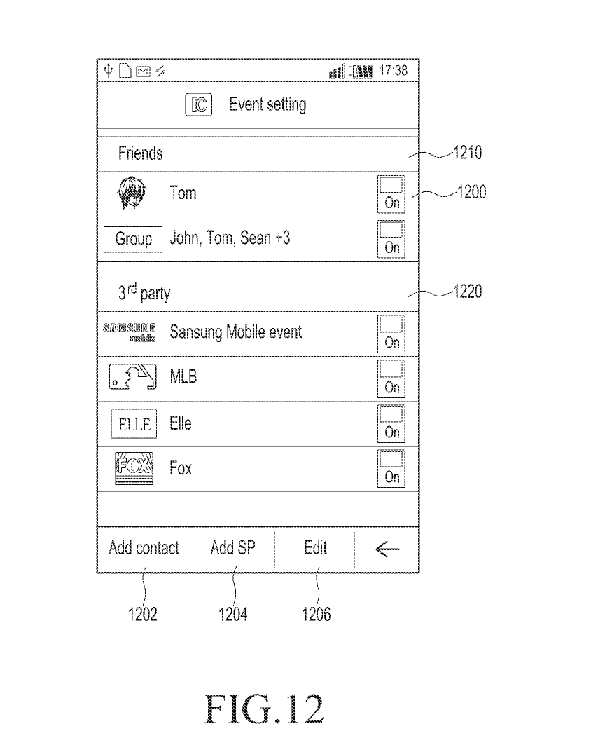

FIG. 12 is a diagram illustrating a screen for an event transmission/reception setting in a user equipment according to an embodiment of the present disclosure.

Referring to FIG. 12, the user equipment 100 may set an acquaintance or a friend among the third-party user equipments 200 like Friends 1210 as an event reception object or set a desired object among the third-party application servers 230 or the service providers 220 like 3rd party 1220 as an event reception object. Further, the user equipment 100 may perform an on/off setting on whether to receive an event from a specific event reception object, as indicated by reference numeral 1200.

Further, the user equipment 100 may display Add contact 1202 for adding an acquaintance or a friend among the third-party user equipments 200 to the screen for an event transmission/reception setting as an event reception object, Add SP 1204 for adding a desired object among the third-party application servers 230 or the service providers 220 as an event reception object, and Edit 1206 for changing or removing the previously set event reception objects.

According to the present disclosure described above, an event may be transmitted or received between users using a calendar protocol in a calendar application of the user equipment 100. Further, according to the present disclosure, an event is not shared with one web account, but is transmitted to at least one third-party user who desires to share a specific event using a calendar protocol in each user equipment so that the event can be easily transmitted to the user to share the event for each event.

Various methods according to an embodiment of the present disclosure may be implemented in a program command form that may be executed through various computer elements and may be recorded in a computer readable recording medium. The computer readable recording medium may include program commands, data files, data structures, and the like, individually or in combination. The program command recorded in the medium may be a program command designed specifically for the present disclosure or may be a program command well-known to one of ordinary skill in the art.

The foregoing method for processing a user-customized page of the present disclosure may be implemented in an executable program command form by various computer means and be recorded in a non-transitory computer readable recording medium. In this case, the non-transitory computer readable recording medium may include a program command, a data file, and a data structure individually or a combination thereof In the meantime, the program command recorded in a recording medium may be specially designed or configured for the present disclosure or be known to a person having ordinary skill in a computer software field to be used. The non-transitory computer readable recording medium includes Magnetic Media, such as a hard disk, a floppy disk, or a magnetic tape, an Optical Media, such as a Compact Disc Read Only Memory (CD-ROM) or a Digital Versatile Disc (DVD), a Magneto-Optical Media, such as a floptical disk, and a hardware device, such as a ROM, a RAM, a flash memory for storing and executing program commands. The non-transitory computer readable recording medium can also be distributed over network coupled computer systems so that the computer readable code is stored and executed in a distributed fashion. Further, the program command includes a machine language code created by a complier and a high-level language code executable by a computer using an interpreter. The foregoing hardware device may be configured to be operated as at least one software module to perform an operation of the present disclosure.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A user equipment comprising:
a calendar unit configured to store calendar data and display a calendar at a request of a user;
an event managing unit configured to manage an event on the calendar; and
an event transmitting/receiving unit configured to transmit an event of the user equipment to an external apparatus and receive an event from the external apparatus by using a calendar protocol.

2. The user equipment of claim 1, wherein the external apparatus comprises at least one of a third-party user equipment, a service provider, and a third-party application server.

3. The user equipment of claim 1, wherein the event comprises at least one of a list-type event and a template-type event.

4. The user equipment of claim 1, wherein the template-type event is an invitation event.

5. A method for transmitting an event using a calendar protocol from a user equipment, the method comprising:
displaying an event on a calendar;
selecting an event and an external apparatus to which the event is to be transmitted; and
transmitting the selected event to the external apparatus using the calendar protocol.

6. The method of claim 5, wherein the external apparatus comprises at least one of a third-party user equipment, a service provider, and a third-party application server.

7. The method of claim 5, wherein the event includes at least one of a list-type event and a template-type event.

8. A method for receiving an event using a calendar protocol by a user equipment, the method comprising:
receiving an event using the calendar protocol from an external apparatus; and
displaying the received event on a corresponding date and time on a calendar.

9. The method of claim 8, wherein the external apparatus includes at least one of a third-party user equipment, a service provider, and a third-party application server.

10. The method of claim 8, wherein the event includes at least one of a list-type event and a template-type event.

11. A non-transitory computer-readable recording medium having recorded thereon a program, which, when executed by a computer, implements the method of claim 5.

12. A non-transitory computer-readable recording medium having recorded thereon a program, which, when executed by a computer, implements the method of claim 8.
